(19) United States
(12) Patent Application Publication
(10) Pub. No.: US 2016/0203407 A1
(43) Pub. Date: Jul. 14, 2016

(54) Maintenance Service Method and Maintenance Service System

(71) Applicant: HITACHI, LTD., Chiyoda-ku, Tokyo (JP)

(72) Inventors: Hiroto SASAKI, Tokyo (JP); Yoshikazu ISHII, Tokyo (JP); Kimiyoshi MACHII, Tokyo (JP); Kaoru KAWABATA, Tokyo (JP)

(73) Assignee: HITACHI, LTD., Chiyoda-ku, Tokyo (JP)

(21) Appl. No.: 14/914,293

(22) PCT Filed: Aug. 28, 2013
(86) PCT No.: PCT/JP2013/072939

§ 371 Date: Feb. 25, 2016

(51) Int. Cl. G06N 7/00; G06N 99/00

(52) U.S. Cl. CPC G06N 7/005; G06N 99/005

(57) ABSTRACT

It is an object of the present invention to provide a maintenance service method capable of reducing the number of machine parts to be replaced while suppressing the number of times of failures of an apparatus even when an accurate failure probability distribution cannot be estimated concerning single machine parts. Solving means of the present invention is characterized by setting, according to at least one of a failure probability distribution and a performance deterioration probability distribution set for each of machine part types, the number of machine parts to be replaced, setting machine part replacement priority from at least one of the probability distribution and an operation situation or a machine part state, and listing, according to the machine part replacement priority, machine parts equivalent to the number of machine parts to be replaced.

### TECHNICAL FIELD

The present invention relates to a maintenance service method and a maintenance service system used in providing maintenance services.

### BACKGROUND ART

Maintenance services in recent years have developed from time-based maintenance for replacing an apparatus in a fixed period into state-based maintenance for applying a machine failure diagnosis technique to monitor machine part states of an apparatus and replacing machine parts in order from a machine part that is most likely to fail and into risk-based maintenance for drawing up a replacement schedule taking into account a tradeoff between costs for replacing an apparatus and the magnitude of a risk in actual occurrence of a failure. Various maintenance service systems for efficiently performing maintenance services have been sophisticated.

As a background art in this technical field, there is JP-A-2008-9990 (Patent Literature 1) The publication has an object of “providing a technique that can reduce costs concerning maintenance pots and also reduce downtime of products” and describes, as one means for solving problems, “calculating, on the basis of a failure probability distribution of consumable supplies, a value in the vicinity of an interval at which the failure probability is predicted to be equal to or higher than a predetermined probability” as a replacement interval of machine parts

### CITATION LIST

### Patent Literature

Patent Literature 1: JP-A-2008-9990

### SUMMARY OF INVENTION

### Technical Problem

In general, even if it is attempted to estimate, concerning single machine parts of an apparatus, a failure probability distribution on the basis of maintenance history data, it is necessary to collect, as a data set to be used, failure instances by an amount corresponding to types of maintenance history data of machine parts in use. When a sufficient amount of failure instances cannot be collected, it is difficult to estimate an accurate failure probability from the maintenance history data For example, the maintenance history data is created for each of companies to which maintenance services are provided. Therefore, a sufficient amount of failure instances cannot be collected simply by calculating a failure probability in each of the companies. It is difficult to estimate an accurate failure probability.

In Patent Literature 1, on the basis of a failure probability distribution of consumable supplies, a value in the vicinity of an interval, at which the failure probability is predicted to be equal to or higher than a predetermined probability is calculated as a replacement interval of machine parts, in this case, concerning consumable supplies reaching the predetermined probability or more, replacement is carried out even if the consumable supplies are machine parts for which the replacement is unnecessary. Therefore, it is likely that the replacement of the machine parts is performed more than necessary.

Therefore, it is an object of the present invention to provide a maintenance service method capable of reducing the number of machine parts to be replaced while suppressing the number of times of failures of an apparatus even when an accurate failure probability distribution cannot be estimated concerning single machine parts.

### Solution to Problem

In order solve the problems, the present invention is characterized by setting, according to at least one of a failure probability distribution and a performance deterioration probability distribution set for each of machine part types, the number of machine parts to be replaced, setting machine part replacement priority from at least one of the probability distribution and an operation situation or a machine part state, and listing, according to the machine part replacement priority, machine parts equivalent to the number of machine parts to be replaced.

Advantageous Effect of Invention

According to the present invention, even when an accurate failure probability distribution cannot be estimated concerning single machine parts, since machine parts having high failure probabilities or high performance deterioration probabilities of an apparatus among an entire machine part group are preferentially replaced, it is possible to suppress an increase in the number of failure or performance deterioration cases. Further, since replacement of an appropriate number of machine parts conforming to a failure probability or performance deterioration probability distribution is performed, it is possible to reduce the number of machine parts to be replaced and reduce maintenance costs.

### BRIEF DESCRIPTION OF THE DRAWINGS

FIG. 1 is an example of a configuration diagram a maintenance service system.

FIG. 2 is an example of a work flow in which a maintenance client 1 is used.

FIG. 3 is an example of a flowchart for explaining processing by a maintenance-schedule creating unit 205.

FIG. 4 is an example of a flowchart for explaining processing in step S204 for calculating a failure rate.

FIG. 5 is a conceptual diagram used for explanation of step S204 for calculating a failure rate.

FIG. 6 is a conceptual diagram used for explanation of step S205 for calculating the number of machine parts to be replaced.

FIG. 7 is an example of a flowchart for explaining processing in step S206 for calculating machine part replacement priority.

FIG. 8 is a setting example of a machine part state of a machine-part-state setting unit 103.

FIG. 9 is an example of a replacement machine parts list obtained in processing step S208.

FIG. 10 is a conceptual diagram used for explanation of step S209 for adjusting a schedule.

FIG. 11 is an example of a diagram representing a relation between a cumulative load and a failure or performance deterioration probability.

FIG. 12 is an example of a diagram showing the cumulative load and the failure or performance deterioration probability distribution.

FIG. 13 is an example of a diagram representing a relation between the cumulative load and a failure rate.

FIG. 14 is an example of a diagram representing a relation between the cumulative load and the number of machine parts managed by a maintenance company.

### DESCRIPTION OF EMBODIMENTS

Embodiments of the present invention are explained below with reference to the drawings. Note that the present invention can be applied to, for example, maintenance services for elevators and escalators and maintenance services in railroads, plants, buildings, factories, and the like.

### First Embodiment

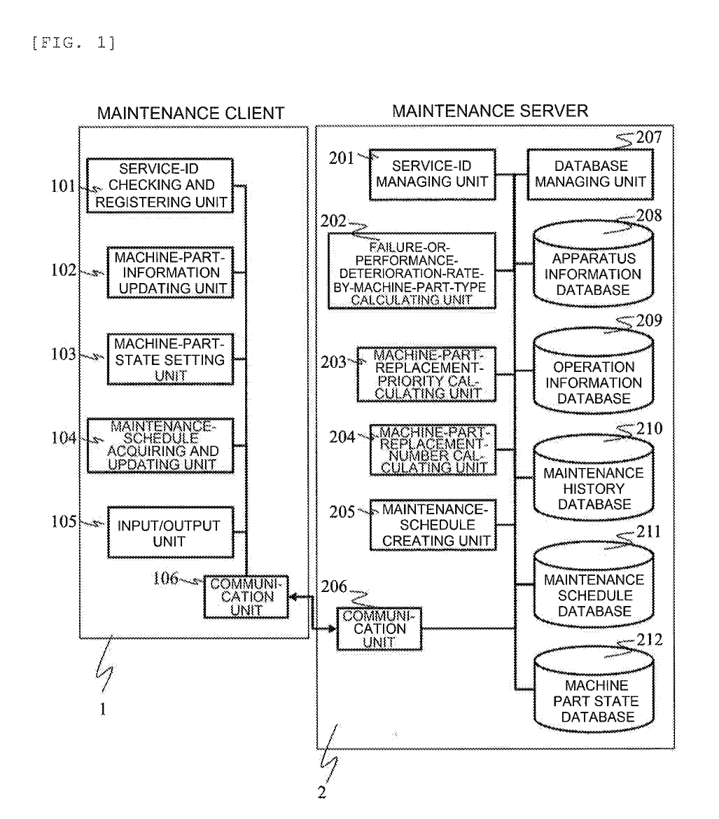

FIG. 1 is an example of a configuration diagram of a maintenance service system. A maintenance client 1 is a terminal apparatus used for maintenance services for computers, cellular phones, PHSs, maintenance dedicated terminals, and the like. The maintenance client 1 includes a service-ID checking and registering unit 101, a machine-part-information updating unit 102, a machine-part-state setting unit 103, a maintenance-schedule acquiring and updating unit 104, an input/output unit 105, and a communication unit 106. A maintenance server 2 includes a service-ID managing unit 201, a failure-or-performance-deterioration-rate-by-machine-part-type calculating unit 202, a machine-part-replacement-priority calculating unit 203, a machine-part-replacement-number calculating unit 204, a maintenance-schedule creating unit 205, a communication unit 206, a database managing unit 207, an apparatus information database 208, an operation information database 209, a maintenance history database 210, a maintenance schedule database 211, and a machine part state database 212. The maintenance server 2 performs, using the communication unit 206, transmission and reception of data to and from the communication unit 106 of the maintenance client 1 via the Internet, a private network, a cloud, or the like.

First, functions of the maintenance client 1 are explained. The service-ID checking and registering unit 101 acquires, from a user of the maintenance client 1, a service identification number (hereinafter, service ID) of a maintenance target apparatus input from the input/output unit 105. By inquiring the service-ID managing unit 201 of the maintenance server 2 about the acquired service ID, the maintenance client 1 can acquire profile information of the maintenance service such as a type and a period of a contract, a maintenance target apparatus, and a replacement target machine part. When the service ID is not managed by the service-ID managing unit 201, the service ID can be registered as a new service ID together with the profile information of the maintenance service.

The machine-part-information updating unit 102 stores, in the operation information database 209, via the database managing unit 207 of the maintenance server 2, operation information necessary for a maintenance service such as operation times and the numbers of times of operation and average loads and cumulative loads of an apparatus and machine parts configuring the apparatus input by the user via the input/output unit 105. The machine-part-information updating unit 102 stores maintenance history information such as update periods of the machine parts in the maintenance history database 210. Further, the machine-part-information updating unit 102 stores, in the apparatus information database 208, apparatus information such as types and the numbers of machine parts configuring apparatuses, replacement target machine parts serving as replacement targets among the machine parts, and a failure or performance deterioration, probability distribution of each of machine part types of the replacement target machine part.

The machine-part-state setting unit 103 stores, in the machine part state database 212, via the database managing unit 207 of the maintenance server 2, information concerning machine part states such as a damage state and abnormality of machine parts obtained during maintenance work input, by the user via the input/output unit 105.

The maintenance-schedule acquiring and updating unit 104 acquires, via the database managing unit 207, maintenance schedule information such as an implementation planned period of maintenance work, a machine part replacement period, and a replacement target machine part stored in the maintenance schedule database 211. The maintenance-schedule acquiring and updating unit 104 stores, in the maintenance schedule database 211, maintenance schedule information obtained by the user changing the acquired maintenance schedule information via the input/output unit 105.

Functions not explained above among the functions of the maintenance server 2 are explained. The failure-or-performance-deterioration-rate-by-machine-part-type calculating unit 202 calculates, using a failure or performance deterioration probability distribution for each of machine part types stored in the apparatus information database 208, a failure rate at which an apparatus fails or causes performance deterioration because of machine parts of certain machine part type. The failure-or-performance-deterioration-rate-by-machine-part-type calculating unit 202 learns, using maintenance history information concerning whether replacement of a machine part was necessary in actual maintenance work stored in the maintenance schedule database 211, a failure or performance deterioration probability distribution of the machine part type. As a learning method, it is possible to learn the failure or performance deterioration probability distribution using general Bayesian learning. Other methods may be used. Consequently, it is possible to improve accuracy of the failure or performance deterioration probability distribution.

The maintenance-schedule creating unit 205 creates, using the order of the machine part replacement priority calculated by the machine-part-replacement-priority calculating unit 203 and the number of machine parts to be replaced calculated by the machine-part-replacement-number calculating unit 204, a maintenance schedule mainly including replacement periods of machine parts and replacement target machine parts. The series of processing by the functions is explained in detail below.

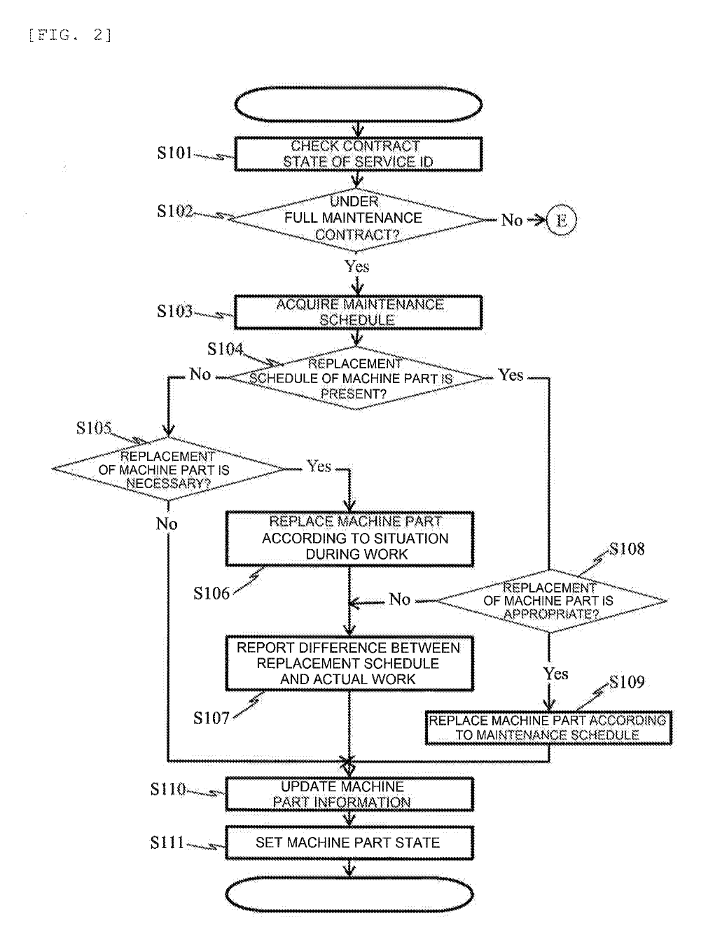

FIG. 2 is an example of a maintenance work flow in which the maintenance client 1 is used. In step S101, the service-ID checking and registering unit 101 inquires the maintenance server 2 about and checks, from input information, a contract state of a service ID, a maintenance target apparatus, and a replacement target machine part input by a maintenance operator If, in step S102, the contract state at a point of maintenance work is under a contract with a maintenance service (hereinafter, full maintenance contract) performed at a fixed amount in every period, in step S103, the maintenance-schedule acquiring and updating unit 104 acquires a maintenance schedule from the maintenance schedule database 211 of the maintenance server 2. If the contract state is not under the full maintenance contract in step S102, the maintenance operator ends the maintenance work. If, in step S104, the replacement target machine part is present in the maintenance schedule acquired in step S103, the maintenance operator checks an actual machine part state in step S108. If replacement of the machine part is appropriate, in step S109, the replacement operator replaces the machine part according to the maintenance schedule.

If the replacement of the machine part is not appropriate in step S108, in step S107, the machine-part-information updating unit 102 stores a difference between the replacement schedule and actual work in the maintenance history database 210. If a replacement schedule of a machine part is absent at the point of the maintenance work in step S104, in step S105, the maintenance operator checks an actual machine part state and checks whether replacement of the machine part is unnecessary If the replacement of the machine part is necessary in step S105, although the replacement of the machine part is absent in the work schedule, the maintenance operator replaces the machine part in step S106. In step S107, the machine-part-information updating unit 102 stores the difference between the replacement schedule and the actual work in the maintenance history database 210. If the check of the replacement schedule of the machine part and the machine part replacement end, in step S110, the machine-part-information updating unit 102 stores maintenance content in the maintenance history database 210 with the point of the maintenance work set as an update period and updates machine part information such as operation times and the numbers of times of operation and average loads and cumulative loads of the maintenance target apparatus and the replacement target machine parts and stores the machine part information in the operation information database 209. By adopting such a procedure, the maintenance operator can perform the maintenance work using the maintenance client 1.

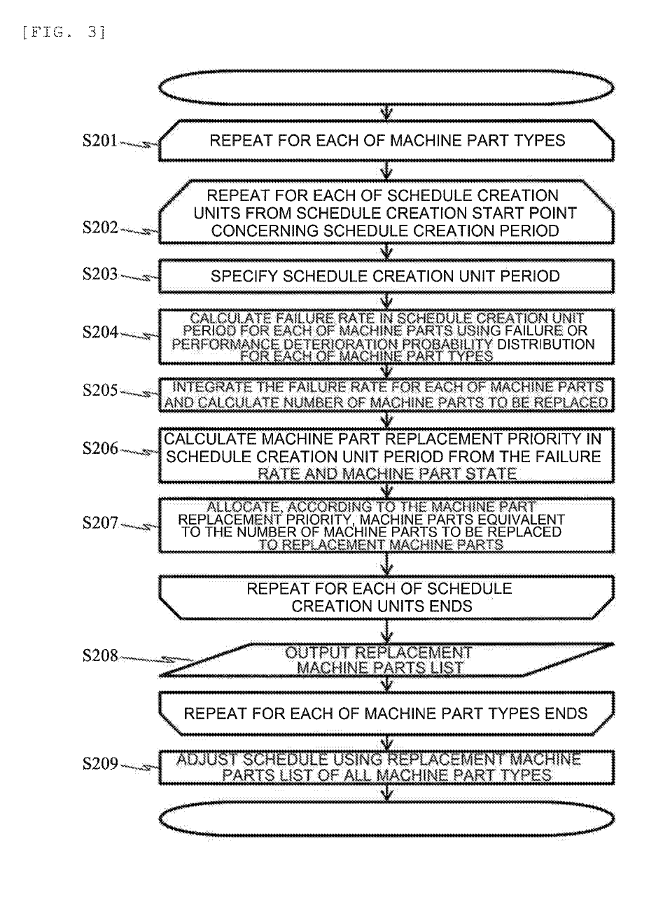

FIG. 3 is an example of a flowchart for explaining processing by the maintenance-schedule creating unit 205. In step S201, the maintenance-schedule creating unit 205 repeats step S202 to step S208 for each of The machine part types. Concerning a period in which a maintenance work schedule is undecided, the maintenance-schedule creating unit 205 creates a maintenance schedule of a schedule creation period from a schedule creation start point. The maintenance schedule is created in order from the schedule creation start point in each of schedule creation units such as one week, one month, three months, half a year, and one year. Therefore, in step S202, the maintenance-schedule creating unit 205 repeats step S203 to step S207 by the schedule creation period in each of the schedule creation units from the schedule creation start point.

In step S203, the maintenance-schedule creating unit 205 specifies a schedule creation unit period in which a maintenance schedule is created. In step S204, the failure-or-performance-deterioration-rate-by-machine-part-type calculating unit 202 calculates a failure ratio in the schedule creation unit period for each of machine parts from failure or performance deterioration probability distribution for each of machine part types. (In the following explanation, although description is omitted concerning a performance deterioration rate, the performance deterioration rate may be calculated using the performance deterioration probability distribution according to necessity.) The failure rate indicates at which rate the machine part fails in the schedule creation unit period. In step S205, the machine-part-replacement-number calculating unit 204 integrates the failure rate concerning all machine parts of the machine part type managed by a maintenance company. The integrated failure rate corresponds to an expected value of the number of machine parts failing in the schedule creation unit period of the machine parts of the machine part type. That is, if the machine parts are replaced by the number of this numerical value, even if replacement is not performed for the other machine parts, it is possible to suppress the number of machine parts that actually fail. In this calculation, failure instances concerning all the machine parts of the machine part type managed by the maintenance company can be utilized. Therefore, even when only client companies cannot collect a sufficient amount of failure instances, it is possible to provide a maintenance service with a more accurate probability distribution while suppressing the number of times of failure of the apparatus. Note that the present invention does not always have to be applied to all the machine parts of the machine part type managed by the maintenance company and may be applied to a part of the machine parts if a sufficient amount of instances to which the present invention can be applied are provided.

In step S206, the machine-part-replacement-priority calculating unit 203 calculates machine part replacement. priority of the machine parts in the schedule creation unit period using the failure rate and the information concerning the machine part state acquired from the machine part state database 212. Details of processing in step S204 to step S206 are explained below. The maintenance-schedule creating unit 205 allocates, according to the machine part replacement priority obtained in step S206, as replacement machine parts in the schedule creation unit period, the machine parts equivalent to the number of machine parts to be replaced obtained in step S205 (step S207). When the allocation of the replacement machine parts ends concerning all schedule creation periods in step S202, in step S208, the maintenance-schedule creating unit 205 outputs the allocation of the replacement machine parts as a replacement machine parts list. When the repetition for each of the machine part types in step S201 ends, in step S209, the maintenance operator adjusts a schedule using the replacement machine parts list of all the machine part types.

By adopting such a configuration, even when an accurate failure probability distribution cannot be estimated. concerning the single machine parts, by using the maintenance history database managed by the maintenance company, it is possible to reduce the number of machine parts to be replaced while suppressing the number of times of failure of the apparatus and reduce maintenance costs necessary for a maintenance job. Qualitatively, it is possible to reduce maintenance costs in all the machine parts managed by the maintenance company taking into account variations of the machine parts in the failure probability distribution of each of the machine part types using the failure probability distribution rather than reducing maintenance costs using variation of the failure probability distribution of each of the single machine parts.

Details are explained in order concerning the calculation of the failure rate in step S204, the calculation of the number of machine parts to be replaced in step S205, and the calculation of the machine part replacement priority in step S206.

FIG. 4 is an example of a flowchart for explaining processing in S204 for calculating a failure rate. In step S301, the failure-or-performance-deterioration-rate-by-machine-part-type calculating unit 202 repeats, for each of the machine parts, step S302 to step S305 concerning all the managed machine parts of the machine part type. In step S302, the failure-or-performance-deterioration-rate-by-machine-part-type type calculating unit 202 estimates a cumulative load of the machine part at a start point of the schedule creation unit period and sets the cumulative load as an initial load. In step S303, the failure-or-performance-deterioration-rate-by-machine-part-type calculating unit 202 estimates a cumulative load of the machine part at an end point of the schedule creation unit period and sets the cumulative load as an end time load. The failure-or-performance-deterioration-rate-by-machine-part-type calculating unit 202 performs the estimation of the cumulative loads in step S302 and step S303 on the basis of the operation information such as the operation times and the numbers of times of operation and the average loads and the cumulative loads of the machine parts stored in the operation information database 209. As an example, the failure-or-performance-deterioration-rate-by-machine-part-type calculating unit 202 calculates the cumulative loads assuming that the machine part is operated with the same average load and in the same operation time per unit time from the start point to the end point of the schedule creation unit period.

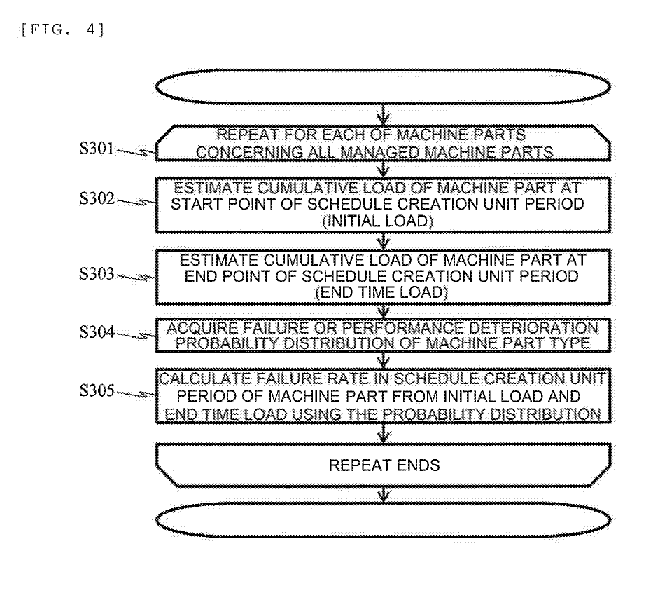

In step S304, the failure-or-performance-deterioration-rate-by-machine-part-type calculating unit 202 acquires a failure or performance deterioration probability distribution of the machine part type of the machine part from the apparatus information database 208. In step S305, the failure-or-performance-deterioration-rate-by-machine-part-type calculating unit 202 calculates a failure rate in the schedule creation unit period of the machine part from an initial. load and an end time load of the probability distribution. The failure rate indicates at which rate the apparatus fails or is deteriorated in performance because of the machine part in the schedule creation unit period. As a specific calculation method, the failure rate is calculated as a rate of a probability that the apparatus fails or is deteriorated in performance from an initial load point to an end time load point of the cumulative load to a probability that the apparatus does not fail or is not deteriorated in performance before the initial load point of the cumulative load. An example of the failure rate in step S304 and step S305 is explained with reference to FIG. 5. A failure or performance deterioration probability distribution 305 receives a cumulative load 300 as an input and returns a probability that the apparatus fails or is deteriorated in performance because of the machine part before the input cumulative load. That is, the failure or performance deterioration probability distribution 305 receives an initial load A(301) as an input and returns a probability B(303) that the apparatus fails or is deteriorated in performance before the initial load A(301). Similarly, the failure or performance deterioration probability distribution 305 receives an end time load A′(302) as an input and returns a probability B′(304) that the apparatus fails or is deteriorated in performance before the end time load A′(302). If this is used, the failure rate is calculated by {B′(304)−B(303)}/{1(305)−B(303)}.

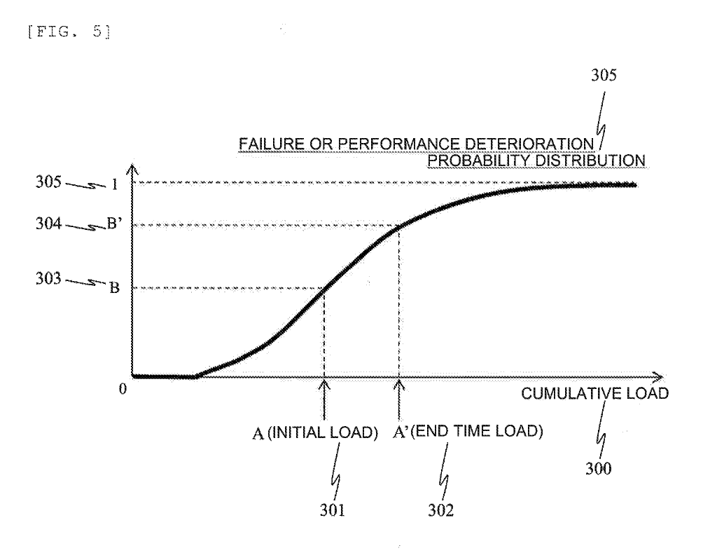

The calculation of the number of machine parts to be replaced in step S205 is explained with reference to FIG. 6 A failure or performance deterioration probability distribution 401 receives a cumulative load 402 as an input and returns a probability 403 that the apparatus fails or is deteriorated in performance because of the machine part before the input cumulative load. Therefore, in cumulative load points 404, in terms of all machine parts 406 managed by the maintenance company, replacement of the machine parts by a number corresponding to the probability 403 of each of the machine parts is necessary. Necessity of replacement of the remaining machine parts is low. That is, necessity of replacement is low concerning 90% of the machine parts, the cumulative load of which is 10% life. Necessity of replacement is low concerning 50% of the machine parts, the cumulative load of which is 50% life. If the machine parts managed by the maintenance company can be arranged according to priority (in FIG. 6, machine part replacement priority 405; conceptually indicated by light and shade of a color), which is the order of necessity of replacement of the machine parts managed by the maintenance company, it only the machine parts are replaced in advance by a number corresponding to the probability 403 of each of the machine parts (in FIG. 6, the machine parts above a replacement line 407) before the cumulative load points 404, even if the remaining machine parts are not replaced, it is possible to suppress the number of the machine parts in which failure or performance deterioration occurs. As indicated by the machine part replacement priority 405 in FIG. 6, when one hundred machine parts are prioritized by the light and shade of the color, in the cumulative loads (10% life, 20% life, . . . ), replacement is unnecessary concerning non-replacement portions with the dark color. The priority, which is the replacement order, is explained below. The failure rate calculated in step S305 indicates at which rate the apparatus fails or is deteriorated in performance because of the machine part in the schedule creation unit period. Therefore, if, in step S205, the failure rate is integrated concerning all the machine parts of the machine part type managed by the maintenance company, it is possible to calculate the number of machine parts to be replaced necessary to be replaced by the schedule creation unit period. That is, the integrated failure rate can be regarded as an expected value of the number of machine parts that fail in the schedule creation unit period. Therefore, if only the machine parts equivalent to the expected value are replaced, a failure or performance deterioration is suppressed. As an example in actual operation, it is also possible to add up a number sufficient for suppressing the number of failure or performance deterioration cases while collating the integrated value with an estimation error of the probability 403 and a rearrangement error of the machine part replacement priority 405, variation from the expected value of the number of machine parts to fail, and an idea concerning occurrence of a failure or performance deterioration in the maintenance service and set the added-up number as the number of machine parts to be replaced.

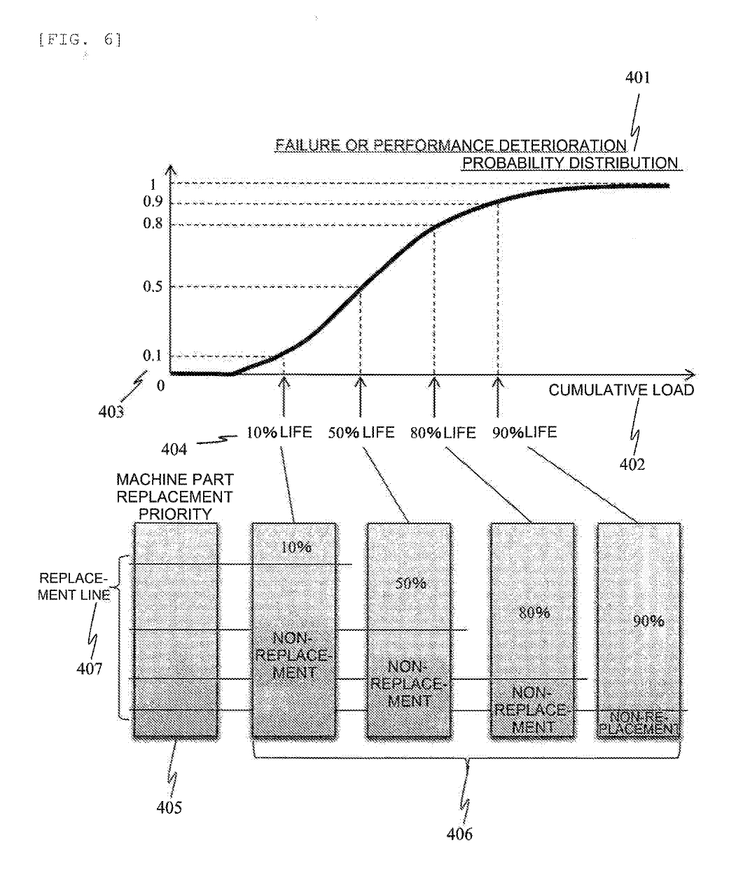

The calculation of the machine part replacement priority in step S206 is explained with reference to FIG. 7. The number of machine parts to be replaced is calculated in the above calculation. However, only with the number of machine parts to be replaced, for example, when there are ten machine parts in the 10% life, it is unknown which machine part should be replaced. Therefore, in order to calculate priority of replacement adjusted to states of the machine parts, calculation explained below is carried out. In step S401, the machine-part-replacement-priority calculating unit 204 calculates a score indicating a deterioration degree of a machine part state for each of the machine parts using the information concerning the machine part states acquired from the machine part state database 212 and converts the score into a point. As a calculation example of the score, for example, the score may be calculated according to a machine part state 502, a machine part number 503, and a check result of a check box 504 set by the machine-part-state setting unit 103 using a checklist 501 shown in FIG. 8, The score may be calculated according to a machine part state of each of the machine parts set by the machine-part-state setting unit 103 on the basis of information directly acquired from a not-shown apparatus via radio or the like. In step S402, the machine-part-replacement-priority calculating unit 203 multiplies together the point calculated from the score and the failure rates of the machine parts obtained in step S204 and calculates weights for determining the replacement order of the machine parts. In step S403, the machine-part-replacement-priority calculating unit 203 sets replacement priority of the machine parts in the descending order of the weights.

By adopting the configuration in step S205, while suppressing the number of failure occurrence cases, it is possible to use the machine parts for a long period and reduce maintenance costs compared with a maintenance service system for replacing all machine parts, the probability 403 of which reaches a fixed value.

In the calculation of the machine part replacement priority in step S206, by adopting such a configuration, it is possible to calculate machine part replacement priority concerning all the machine parts managed by the maintenance company. Besides, for example, it is also conceivable to adopt a method of performing grouping at the cumulative load points 404 of the machine parts and performing rearrangement of the machine parts belonging to each of groups. However, in that case, when the numbers of machine parts belonging to the groups are small, it is likely that imbalance occurs between the number of failure or performance deterioration cases to occur and the number of machine parts to be replaced. Therefore, it is desirable to calculate the machine part replacement priority concerning all the machine parts managed by the maintenance company.

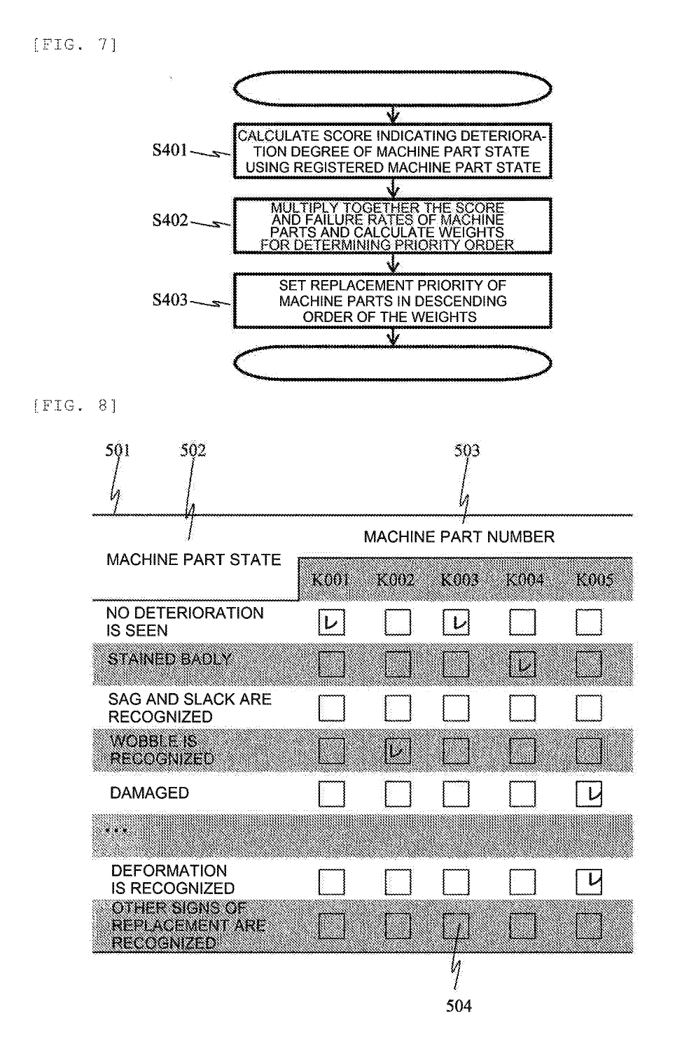

A replacement machine parts list 601 shown in FIG. 9 is an example of a replacement machine parts list obtained in step S208. The replacement machine parts list 601 mainly consists of a replacement period 602 and a replacement target machine part 603. Machine parts to be set as replacement targets are listed for each of the schedule creation unit periods.

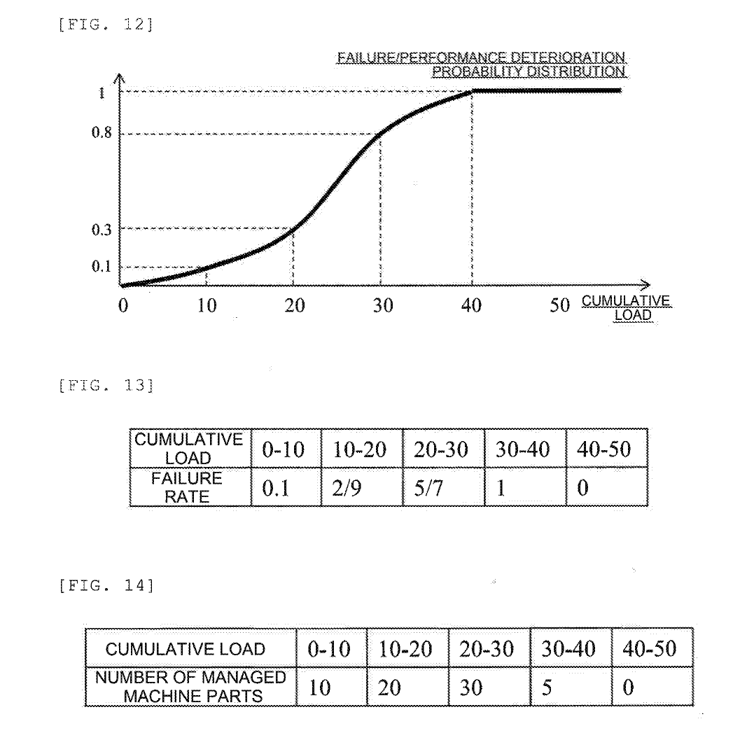

These calculations are explained using a simple example. For example, it is assumed that a failure or performance deterioration probability in a certain machine part type is calculated as shown in FIG. 11. At this point, a failure rate of the machine parts present between cumulative loads of 10 and 20 is calculated as (0.3−0.1)/(1−0.1) A result of calculating the failure rate in cumulative loads is shown in FIG. 13. Subsequently, when the failure rate is integrated concerning all the machine part types managed by the maintenance company, it is possible to calculate the number of machine parts to be replaced necessary to be replaced in the schedule creation unit period. That is, the integration of the failure rate is an expected value of a failure of the machine type in the schedule creation period. In the present invention, the expected value is set as the number of machine parts to be replaced. For example, when cumulative loads and the number of all the machine parts of the machine part type managed by the maintenance company having the cumulative loads are in a relation shown in FIG. 14, by integrating all probability rates for the respective cumulative loads, an expected value of a failure of the machine parts in this period is calculated as 31.87 . . . , which is the number of machine parts to be replaced. It is seen that replacement of 31.87 . . . machine parts is necessary in the schedule creation unit period. Further, since the necessary number of machine parts to be replaced is calculated, to set priority of machine part replacement in the machine part type managed by the maintenance company, the failure rates and the machine part states of the machine parts are multiplied together to calculate machine part replacement priority. The machine parts equivalent to the number of machine parts to be replaced necessary to be replaced are replaced from the top of the order of the machine part replacement priority. By performing the calculation in this way, it is possible to preferentially replace the machine parts having high failure probabilities according to the failure or performance deterioration probability. Compared with when the machine parts exceeding the fixed probability are replaced, it is possible to reduce the number of machine parts to be replaced while suppressing the number of times of failure of the apparatus. It is possible to reduce maintenance costs necessary for a maintenance job.

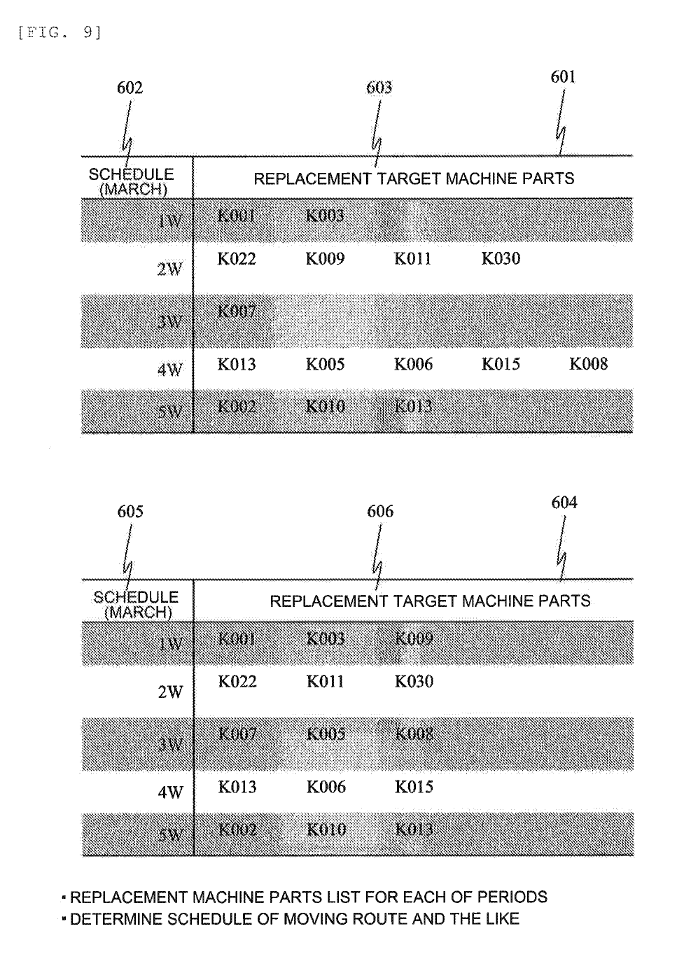

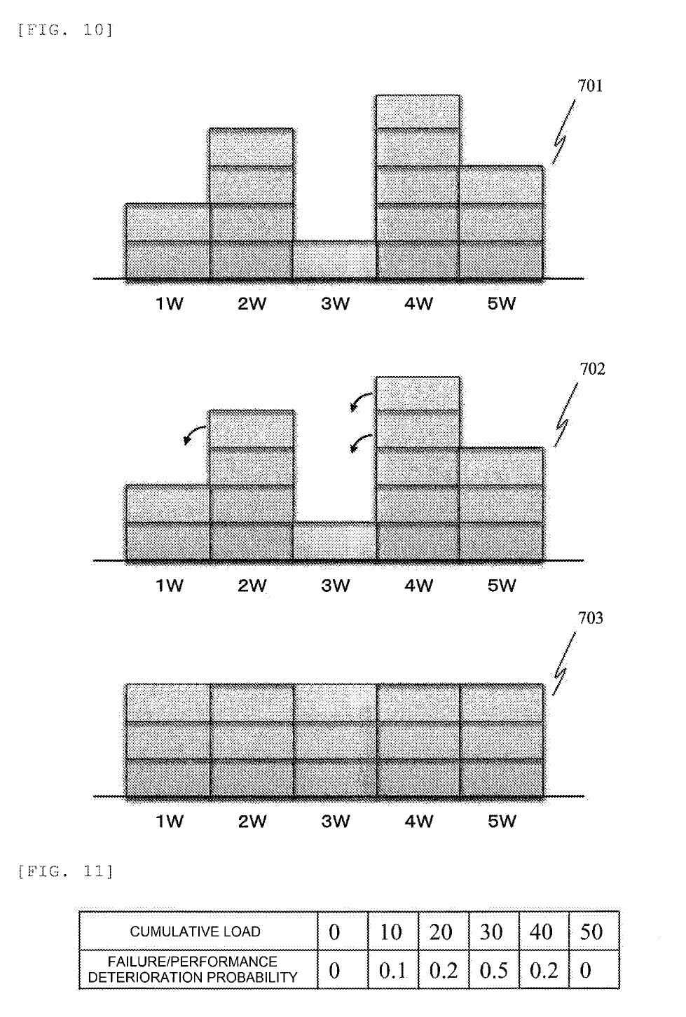

FIG. 10 shows an example of the schedule adjustment in step S209 in the maintenance-schedule creating unit 205. In FIG. 10, leveling of a work load is performed. Front loading 702 of machine part replacement in a period with a large load is performed from a work load 701 for each of the schedule creation unit periods before adjustment to obtain a list 703 of the machine parts after the work load leveling. By performing the front loading 702 of the machine part replacement, it is possible to level the work load while suppressing occurrence of a failure or performance deterioration. An example of the work load leveling performed using the replacement machine parts list 601 is shown in a replacement machine parts list 604 shown in FIG. 9. In the schedule adjustment in step S209, besides, work generally performed as adjustment of a maintenance schedule such as minimization of a visiting route and minimization of the number of times of maintenance and inspection may be performed.

With the configuration explained above, according to the present invention, since the machine parts having high failure or performance deterioration probabilities in the entire machine part group are preferentially replaced, it is possible to suppress an increase in the number of failure or performance deterioration cases and it is possible to reduce maintenance costs for performing replacement of an appropriate number of machine parts conforming to a failure r performance deterioration probability distribution.

### REFERENCE SIGNS LIST

1 maintenance client
2 maintenance server
101 service-ID checking and registering unit
102 machine-part-information updating unit
103 machine-part-state setting unit
104 maintenance-schedule acquiring and updating unit
105 input/output unit
106 communication unit
201 service-ID managing unit
202 failure-or-performance-deterioration-rate-by-machine-part-type calculating unit
203 machine-part-replacement-priority calculating unit
204 machine-part-replacement-number calculating unit
205 maintenance-schedule creating unit
206 communication unit
207 database managing unit
208 apparatus information database
209 operation information database
210 maintenance history database
211 maintenance schedule database
212 machine part state database

1. A maintenance service method comprising:
setting, according to at least one of a failure probability distribution and a performance deterioration probability distribution set for each of machine part types, a number of machine parts to be replaced;
setting machine part replacement priority from at least one of the probability distribution and an operation situation or a machine part state; and
listing, according to the machine part replacement priority, machine parts equivalent to the number of machine parts to be replaced.

2. The maintenance service method according to claim 2, further comprising learning at least one of the failure probability distribution and the performance deterioration probability distribution of the machine part type using maintenance history information indicating whether replacement of a machine part in actual maintenance work was necessary.

3. The maintenance service method according claim 1, wherein the number of machine parts to be replaced is calculated by calculating a failure rate in a maintenance schedule creation period from at least one of the failure probability distribution and the performance deterioration probability distribution set for each of the machine part types and integrating the failure ratio for each of the machine part types by a number of machine parts set as management targets.

4. The maintenance service method according to claim 3, wherein the machine part replacement priority is calculated by integrating the failure rate for each of the machine part types and the machine part state.

5. The maintenance service method according to claim 4, wherein a maintenance schedule of the machine parts to be listed is created.

6. A maintenance service system comprising:
an apparatus information database that stores at least one of a failure probability distribution and a performance deterioration probability distribution set for each of machine part types;
a maintenance history database that stores at least one of an operation information database that stores an operation situation and information concerning a machine part state;
a machine-part-replacement-number calculating unit that calculates, according to at least one of the failure probability distribution and the performance deterioration probability distribution set for each of the machine part types, a number of machine parts to be replaced; and
a machine-part-replacement-priority calculating unit that calculates machine part replacement priority using at least one of the probability distribution and the operation situation or the machine part state, wherein
the maintenance service system lists machine parts equivalent to the number of machine parts to be replaced according to the machine part replacement priority.

7. The maintenance service system according to claim 6, wherein the maintenance service system learns at least one of the failure probability distribution and the performance deterioration probability distribution of the machine part type using maintenance history information indicating whether replacement of a machine part in actual maintenance work was necessary.

8. The maintenance service system according to claim 6, wherein the machine-part-replacement-number calculating unit calculates the number of machine parts to be replaced by calculating a failure rate in a maintenance schedule creation period from at least one of the failure probability distribution and the performance deterioration probability distribution set for each of the machine part types and integrating the failure ratio for each of the machine part types by a number of machine parts set as management targets.

9. The maintenance service system according to claim 8, wherein the machine-part-replacement-priority calculating unit calculates the machine part replacement priority by integrating the failure rate for each of the machine part types and the machine part state.

10. The maintenance service system according to claim 9, further comprising a maintenance-schedule creating unit that creates a maintenance schedule of the machine parts to be listed.
